(19) United States
(12) Patent Application Publication
(10) Pub. No.: US 2026/0129525 A1
(43) Pub. Date: May 7, 2026

(54) TECHNIQUES FOR CELL HANDOVER USING APERIODIC CHANNEL STATE INFORMATION REFERENCE SIGNALS

(71) Applicant: QUALCOMM Incorporated, San Diego, CA (US)

(72) Inventors: Sandeep Kumar AITHA, SAN MARCOS, CA (US); Changhwan PARK, San Diego, CA (US); Mahdi ZAMANI, San Diego, CA (US); Dominic BOIKO, Thornton, CO (US)

(21) Appl. No.: 18/940,675

(22) Filed: Nov. 7, 2024

(51) Int. Cl. H04W 36/00; H04L 5/00; H04W 74/0833

(52) U.S. Cl. CPC H04W 36/0061; H04L 5/0048; H04W 74/0833

(57) ABSTRACT

Methods, systems, and devices for wireless communications are described. A user equipment (UE) may receive, from a serving cell, a control signal indicating a set of parameters for a target cell available for handover for the UE and indicating the target cell is configured to transmit an aperiodic reference signal during a handover procedure. The UE may receive a command that identifies the target cell for a handover from the serving cell, and the command may indicate one or more resources associated with the aperiodic reference signal. The UE may receive, from the target cell, the aperiodic reference signal over the one or more resources. The UE may transmit a random access message based on time information or frequency information obtained from the aperiodic reference signal.

### FIELD OF TECHNOLOGY

The following relates to wireless communications, including techniques for cell handover using aperiodic channel state information reference signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a serving cell, a control signal indicating a set of parameters for a target cell available for handover for the UE and indicating the target cell is configured to transmit an aperiodic reference signal during a handover procedure, receiving, from the serving cell, a command that identifies the target cell for a handover from the serving cell, where the command indicates one or more resources associated with the aperiodic reference signal, receiving, from the target cell, the aperiodic reference signal over the one or more resources, and transmitting, based on the aperiodic reference signal, a random access message based on time information or frequency information obtained from the aperiodic reference signal.

A UE for wireless communications is described. The UE may include one or more memories storing processor executable code, and one or more processors coupled with the one or more memories. The one or more processors may individually or collectively be operable to execute the code to cause the UE to receive, from a serving cell, a control signal indicating a set of parameters for a target cell available for handover for the UE and indicating the target cell is configured to transmit an aperiodic reference signal during a handover procedure, receive, from the serving cell, a command that identifies the target cell for a handover from the serving cell, where the command indicates one or more resources associated with the aperiodic reference signal, receive, from the target cell, the aperiodic reference signal over the one or more resources, and transmit, based on the aperiodic reference signal, a random access message based on time information or frequency information obtained from the aperiodic reference signal.

Another UE for wireless communications is described. The UE may include means for receiving, from a serving cell, a control signal indicating a set of parameters for a target cell available for handover for the UE and indicating the target cell is configured to transmit an aperiodic reference signal during a handover procedure, means for receiving, from the serving cell, a command that identifies the target cell for a handover from the serving cell, where the command indicates one or more resources associated with the aperiodic reference signal, means for receiving, from the target cell, the aperiodic reference signal over the one or more resources, and means for transmitting, based on the aperiodic reference signal, a random access message based on time information or frequency information obtained from the aperiodic reference signal.

A non-transitory computer-readable medium storing code for wireless communications is described. The code may include instructions executable by one or more processors to receive, from a serving cell, a control signal indicating a set of parameters for a target cell available for handover for the UE and indicating the target cell is configured to transmit an aperiodic reference signal during a handover procedure, receive, from the serving cell, a command that identifies the target cell for a handover from the serving cell, where the command indicates one or more resources associated with the aperiodic reference signal, receive, from the target cell, the aperiodic reference signal over the one or more resources, and transmit, based on the aperiodic reference signal, a random access message based on time information or frequency information obtained from the aperiodic reference signal.

In some examples of the method, user equipment (UEs), and non-transitory computer-readable medium described herein, receiving the aperiodic reference signal may include operations, features, means, or instructions for receiving the aperiodic reference signal in accordance with a configuration, indicated by the set of parameters, for the one or more resources.

In some examples of the method, user equipment (UEs), and non-transitory computer-readable medium described herein, receiving the aperiodic reference signal may include operations, features, means, or instructions for receiving the aperiodic reference signal after the time duration.

In some examples of the method, user equipment (UEs), and non-transitory computer-readable medium described herein, the configuration indicates a quantity of the one or more resources.

In some examples of the method, user equipment (UEs), and non-transitory computer-readable medium described herein, the one or more resources include a set of multiple subsets of resources including first subset of resources and a second subset of resources separated by a time gap.

In some examples of the method, user equipment (UEs), and non-transitory computer-readable medium described herein, the configuration indicates a quantity of the set of multiple subsets of resources and indicates a duration for the time gap.

In some examples of the method, user equipment (UEs), and non-transitory computer-readable medium described herein, receiving the command may include operations, features, means, or instructions for receiving the command that indicates an identification associated with the one or more resources.

In some examples of the method, user equipment (UEs), and non-transitory computer-readable medium described herein, receiving the command may include operations, features, means, or instructions for receiving the command that indicates the one or more resources associated with the aperiodic reference signal as a time duration after reception of the command, where receiving the aperiodic reference signal includes and receiving the aperiodic reference signal after the time duration.

In some examples of the method, user equipment (UEs), and non-transitory computer-readable medium described herein, receiving the command may include operations, features, means, or instructions for receiving the command that indicates a quantity of the one or more resources.

In some examples of the method, user equipment (UEs), and non-transitory computer-readable medium described herein, a quantity of the one or more resources may be based on a frequency range associated with the target cell, a status of the target cell, or a combination thereof.

In some examples of the method, user equipment (UEs), and non-transitory computer-readable medium described herein, receiving the command may include operations, features, means, or instructions for receiving the command that triggers a cell switch procedure or a physical random access channel procedure.

In some examples of the method, user equipment (UEs), and non-transitory computer-readable medium described herein, receiving the control signal may include operations, features, means, or instructions for receiving the control signal that indicates a set of multiple periodic resources associated with periodic reference signals, where the aperiodic reference signal may be associated with a single quasi co location (QCL) associated with the periodic reference signals.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports (CSI-RS) in accordance with one or more aspects of the present disclosure.

FIG. 2 shows an example of a wireless communications system that supports techniques for cell handover using aperiodic CSI-RS in accordance with one or more aspects of the present disclosure.

FIG. 3 shows an example of a timing diagram that supports techniques for cell handover using aperiodic CSI-RS in accordance with one or more aspects of the present disclosure.

FIG. 4 shows an example of a process flow that supports techniques for cell handover using aperiodic CSI-RS in accordance with one or more aspects of the present disclosure.

FIGS. 5 and 6 show block diagrams of devices that support techniques for cell handover using aperiodic CSI-RS in accordance with one or more aspects of the present disclosure.

FIG. 7 shows a block diagram of a communications manager that supports techniques for cell handover using aperiodic CSI-RS in accordance with one or more aspects of the present disclosure.

FIG. 8 shows a diagram of a system including a device that supports techniques for cell handover using aperiodic CSI-RS in accordance with one or more aspects of the present disclosure.

FIGS. 9 and 10 show flowcharts illustrating methods that support techniques for cell handover using aperiodic CSI-RS in accordance with one or more aspects of the present disclosure.

### DETAILED DESCRIPTION

Some wireless communications systems may support mobility of a user equipment (UE) from a network entity associated with a serving cell to a network entity associated with a target cell or candidate cell. In some cases, mobility of the UE may be triggered based on a radio resource control (RRC) based handover d, layer 1 (L1)/layer 2 (L2) triggered mobility (LTM), or a transmission reception point (TRP) switch or activation. After the UE receives the cell switch command to switch to the target cell, the UE may receive reference signals, such as periodic SSB or periodic TRS, from the target cell. The UE may obtain timing information and frequency information for the target cell via the reference signals. Because the reference signals are periodic, the UE may receive the reference signals at a time duration after the cell switch command providing a cell switch delay duration. Reducing the cell switch delay duration may be beneficial to improve communication performance and reduce latency.

Techniques for cell handover using aperiodic channel state information reference signals (CSI-RS) may be employed. In some examples, the UE may may receive an aperiodic reference signal (e.g., CSI-RS) from a target cell, and the UE may transmit a random access message based on time information or frequency information obtained from the aperiodic reference signal. In some examples, the UE may receive, from a serving cell, a control signal indicating a set of parameters for a target cell available for handover for the UE and indicating the target cell is configured to transmit an aperiodic reference signal during a handover procedure. The UE may receive, from a serving cell, a command that identifies the target cell for a handover from the serving cell, and the command may indicates one or more resources associated with the aperiodic reference signal. The UE 115-a may receive, from the target cell, the aperiodic reference signal over the one or more resources. The UE may transmit, based on the periodic reference signal, a random access message based at least in part on time information or frequency information obtained from the aperiodic reference signal.

Aspects of the disclosure are initially described in the context of wireless communications systems. Aspects of the disclosure are further illustrated by and described with reference to a timing diagram, a process flow, apparatus diagrams, system diagrams, and flowcharts that relate to techniques for cell handover using aperiodic CSI-RS.

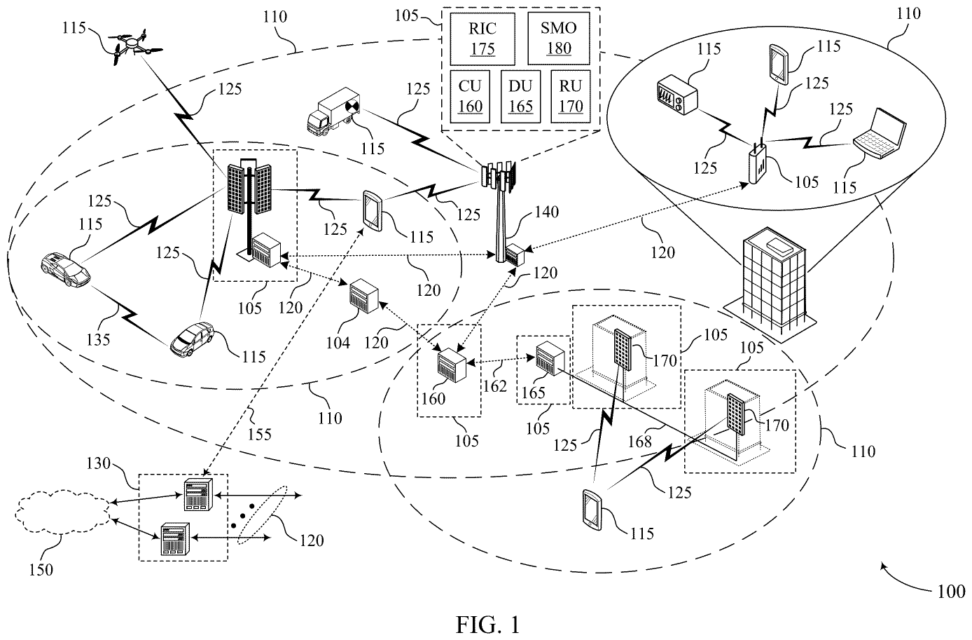

FIG. 1 shows an example of a wireless communications system 100 that supports techniques for cell handover using aperiodic CSI-RS in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for cell handover using aperiodic CSI-RS as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems may support mobility of a UE 115 from a network entity 105 associated with a serving cell to a network entity 105 associated with a target cell or candidate cell. In some cases, mobility of the UE 115 may be triggered based on a RRC based handover command, LTM, or a TRP switch or activation. After the UE 115 receives the cell switch command to switch to the target cell, the UE 115 may receive reference signals, such as periodic SSB or periodic TRS, from the target cell. The UE 115 may obtain timing information and frequency information for the target cell via the reference signals. Because the reference signals are periodic, the UE 115 may receive the reference signals a time duration after the cell switch command providing an cell switch delay duration. It is desired to reduce the cell switch delay duration.

Techniques for cell handover using aperiodic CSI-RS may be employed. In some examples, the UE 115 may may receive an aperiodic reference signal from a target cell, and the UE 115 may transmit a random access message based on time information or frequency information obtained from the aperiodic reference signal. In some examples, the UE 115 may receive, from a serving cell, a control signal indicating a set of parameters for a target cell available for handover for the UE 115 and indicating the target cell is configured to transmit an aperiodic reference signal during a handover procedure. The UE 115 may receive, from a serving cell, a command that identifies the target cell for a handover from the serving cell, and the command may indicates one or more resources associated with the aperiodic reference signal. The UE 115 may receive, from the target cell, the aperiodic reference signal over the one or more resources. The UE 115 may transmit, based on the periodic reference signal, a random access message based at least in part on time information or frequency information obtained from the aperiodic reference signal.

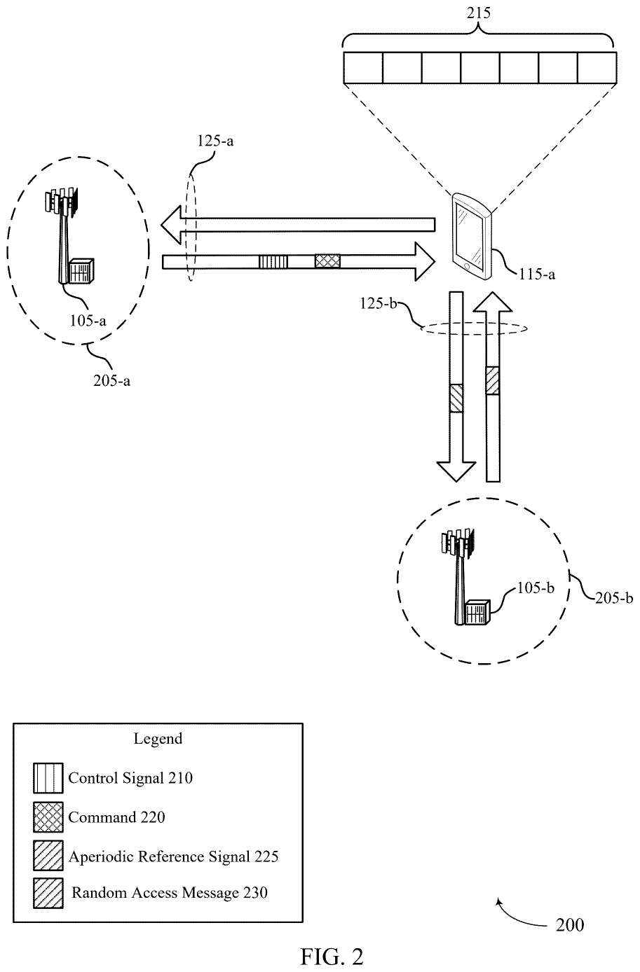

FIG. 2 shows an example of a wireless communications system 200 that supports techniques for cell handover using aperiodic CSI-RS in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a and a network entity 105-b), which may be examples of the corresponding devices as described herein. Each network entity of the one or more network entities may be associated with a respective cell. For example, the network entity 105-a may be associated with a cell, which may be an example of a serving cell 205-a. Similarly, the network entity 105-b may be associated with a cell, which may be an example of a candidate cell or a target cell 205-b. The UE 115-a may be in communication with one or more cells (e.g., serving cell 205-a or target cell 205-b) via the one or more network entities (e.g., network entity 105-a or network entity 105-b.

In some implementations, the UE 115-a may communicate with the network entity 105-a using a communication link 125-a, the UE 115-a may communicate with the network entity 105-b using a communication link 125-b. The communication link 125-a and the communication link 125-b may be examples of a 6th generation (6G), a NR or LTE link between the UE 115-a and the network entity 105-a and the network entity 105-b. The communication link 125-a and the communication link 125-b may include bi-directional links that enable both uplink and downlink communications. For example, the network entity 105-a may transmit downlink signals (e.g., downlink message), such as downlink control signaling and downlink data signals, to the UE 115-a using the communication link 125-a, and the UE 115-a may transmit uplink signals (e.g., uplink messages), including uplink control signaling and uplink data signals to the network entity 105-a using the communication link 125-a. The network entity 105-b may transmit downlink signals (e.g., downlink message), such as downlink control signaling and downlink data signals, to the UE 115-a using the communication link 125-b, and the UE 115-a may transmit uplink signals (e.g., uplink messages), including uplink control signaling and uplink data signals to the network entity 105-b using the communication link 125-b.

The wireless communications system 200 may support mobility of the UE from the serving cell 205-a to the target cell 205-b. In some cases, the UE 115-a may receive, from the serving cell 205-a, a control signal 210 indicating a set of parameters for the target cell 205-b available for handover for the UE 115-a. The control signal 210 may indicate the target cell 205-b is configured to transmit an aperiodic reference signal during a handover procedure. For the target cell 205-b to be switched as a special cell (SpCell), a primary cell (PCell), or a target TRP to be activated, the UE 115-a may be provided, by the serving cell 205-a, a set of resources 215 associated with the aperiodic reference signal. In some cases, the configuration of the set of resources 215 may be provided by RRC signaling. The configuration may include additional time domain parameters.

In some examples, the UE 115-a may receive, from the serving cell 205-a, receiving, a command that identifies the target cell 205-b for a handover from the serving cell 205-a. The command 220 may be a message, such as downlink control information (DCI), a MAC control element (MAC-CE), or an RRC signaling, that indicates to change the status of the target cell (e.g., RRC based handover, LTM, TRP switch or activation). The command 220 may explicitly signal whether the UE 115-a may expect the CSI-RS resource (e.g., aperiodic TRS) from the target cell 205-b. For example, the command 220 may indicates one or more resources 215 associated with the aperiodic reference signal or aperiodic CSI-RS. In some cases, the command 220 may implicitly or explicitly indicate the time duration (from time instance #A to time instance #B) where the UE 115-a may expect the CSI-RS resource from the target cell 205-b. In some examples, the command 220 or the set of parameters of the control signal 210 may indicate a configuration for the resources 215. The configuration for the resources 215 may include a time domain configuration indicating the resources 215 as a time duration after reception of the command 220. A time instance #A may be later than the reception of the command 220 (e.g., 3 ms after HARQ ACK transmission corresponding to the command 220). A time instance #B may be a slot where X sets of the CSI-RS resources are transmitted from the time instance #A. The value of X or quantity of resources 215 may be configured via the control signal (e.g., RRC signaling) or signaled by the command 220 or may be a predetermined quantity. The quantity of resources or the value of X may be different depending on a frequency range (FR) of the target cell 205-b, or status of the target cell 205-b (e.g., known vs. unknown defined by RRM specification).

The UE 115-a may receive, from the target cell 205-b, an aperiodic reference signal 225 over the resources 215. The UE 115-a may obtain time information or frequency information based on the received aperiodic reference signal 225. The UE 115-a may transmit a random access message 230 based on the time information or the frequency information obtained from the aperiodic reference signal 225.

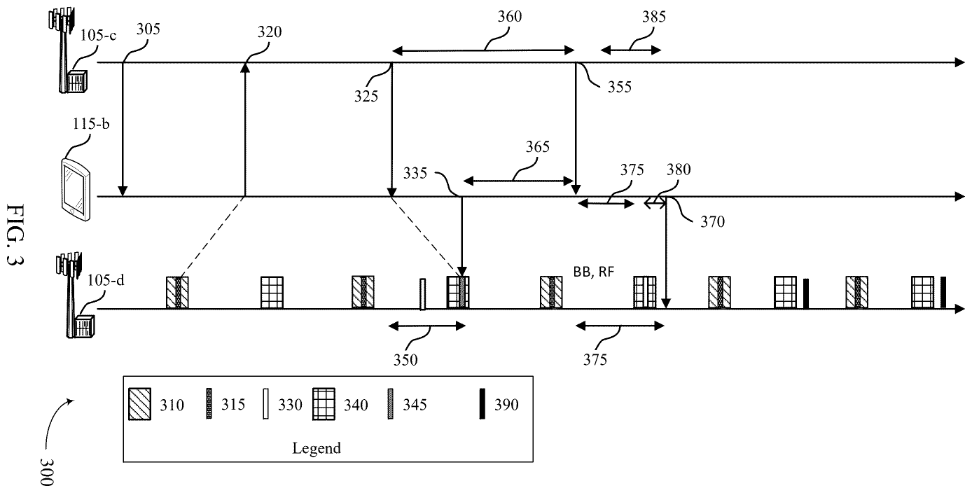

FIG. 3 shows an example of a timing diagram 300 that supports techniques for cell handover using aperiodic CSI-RS in accordance with one or more aspects of the present disclosure. The timing diagram 300 illustrates an LTM cell switch procedure using an aperiodic CSI-RS for latency reduction. The timing diagram 300 may implement or be implemented by one or more aspects described with reference to FIGS. 1 and 2. For example, the LTM cell switch procedure of the timing diagram 300 may be implemented by a serving cell associated with a network entity 105-c, a target cell associated with network entity 105-d, and a UE 115-b which may be examples of respective devices described herein.

At 305, the UE 115-b may receive, from the serving cell associated with the network entity 105-c, a control signal, such as RRC signaling, that indicates an LTM configuration for the target cell available for handover for the UE 115-b. The configuration may include a CSI-RS configuration for time and frequency tracking (e.g., FR time frequency tracking) to enable time and frequency synchronization with the target cell associated with the network entity 105-d. For example, the CSI-RS configuration may indicate that the target cell will transmit aperiodic tracking reference signals (TRS) to allow the UE 115-b to measure and adjust the timing and frequency of the UE 115-b based on the aperiodic TRS. The configuration may include a baseline configuration indicating a set of parameters to be used when the target cell becomes the SpCell. The configuration may also include additional configuration information, where the set of parameters included in the baseline configuration remain the same except for an additional time domain resource configuration. The time domain resource configuration may include the additional configuration that may be temporarily used during early PRACH transmission, LTM cell switch execution, or both early PRACH transmission and LTM cell switch execution. The additional time domain configuration may be defined with respect to physical downlink control channel (PDCCH) order slot for early physical random access channel (PRACH) transmission and LTM cell switch MAC-CE slot. The additional configuration may further include a quantity of repetitions of the CSI-RS which may depend on frequency range of the target cell (frequency range) or status (known vs. unknown defined by RRM specification) of the target cell. In some cases, the additional configuration may be defined as a full set CSI-RS configuration without or separate from the baseline configuration.

The UE 115-b may receive, from the target cell, a synchronization signal block (SSB) burst 310 and a SSB 315 associated with an active transmission configuration indication (TCI) state for early PRACH. At 320, the UE 115-b, based on the SSB burst 310 and SSB 315, may transmit, to the serving cell, a layer one reference signal received power (L1-RSRP) report for the target cell or candidate cell. At 325, the UE 115-b may receive, from the serving cell, a PDCCH order for PRACH, and the command may indicate resources associated with the aperiodic reference signal. In some cases, the PDCCH order may be a DCI, such as a PDCCH order PRACH. The temporary CSI-RS (e.g., aperiodic TRS) is expected to be transmitted from the corresponding target cell from a slot a quantity of slots (e.g., X slots) after a slot corresponding to the PDCCH order. The value for X may be explicitly signaled by the PDCCH order if the configuration include multiple candidate values. The quantity of the temporary CSI-RS bursts (e.g., aperiodic TRS) may be explicitly signaled by the PDCCH order if the configuration includes multiple candidate values.

In some examples, the UE 115-b may receive, from the target cell, a aperiodic temporary TRS burst 330 to allow the UE 115-a to measure and adjust the timing and frequency of the UE 115-a based on the aperiodic TRS burst 330.

At 335, the UE 115-b may transmit, to the target cell, a physical random access channel (PRACH) message on a random access occasion 340. In some cases, the UE 115-b may transmit, to the target cell, the PRACH channel message on a random access channel (RACH) occasion 345 associated with early PRACH for the target cell. The time duration between the PDCCH order for PRACH at 325 and the PRACH message at 335 may be an early PRACH delay 350.

At 355, the UE 115-b may receive, from the serving cell, an LTM cell switch command that may be provided via a MAC-CE. In some cases, the temporary CSI-RS (e.g., aperiodic TRS 330) may be expected to be transmitted from the corresponding target cell from a slot X slots after the slot of the received MAC-CE associated with the LTM cell switch command. The value of X may be explicitly signaled by the MAC-CE (e.g., LTM cell switch command) if the configuration include multiple candidate values. The quantity of the temporary CSI-RS bursts (e.g., aperiodic TRS 330) may be explicitly signaled by the MAC-CE (e.g., LTM cell switch command) if the configuration include multiple candidate values. The time duration between the PDCCH order at 325 and the LTM cell switch command at 355 may be a LTM cell switch preparation duration 360. The time duration between the PDCCH order for PRACH at 335 and the LTM cell switch command at 355 may be a PRACH processing and backhaul delay duration 365.

Based on receiving the LTM cell switch command, the UE 115-b, may receive, from the target cell, the aperiodic TRS 330. At 370, the UE 115-b may transmit, to the target cell, a random access message. The LTM cell switch from the serving cell to the target cell may be complete with RRC reconfiguration completed after the random access procedure with the target cell. The time duration between the LTM cell switch command at 355 and the completion of the LTM cell switch may be a LTM cell switch delay 375. The LTM cell switch delay 375 may comprise a delay 380 associated with processing the MAC and RRC and a delay 380 associated with CSI-RS processing. When the UE 115-b is performing the handover from the serving cell to the target cell, an interruption window 385 may exist where the UE 115-b is out of connection with a cell.

In some examples, the LTM cell switch based on CSI-RS (e.g., aperiodic TRS 330) may provide a latency reduction as compared to the LTM cell switch based on SSB. The UE 115-a may use the aperiodic TRS 330 to obtain timing information and frequency information to synchronize to the target cell. For a use case without the aperiodic TRS, the UE 115-b may rely on SSB 310 and periodic TRS 390, after the LTM command, from the target cell to measure and adjust the timing and frequency of the UE 115-b. Because the SSB 310 and periodic TRS 390 are periodic signals, the UE 115-b may not receive the SSB or periodic TRS for a greater time duration after the aperiodic TRS 330 may be scheduled resulting in a larger time duration for the LTM cell switch and a larger interruption window.

In some cases, the aperiodic TRS may be used for handover for intra-FR to reduce latency. In some cases, the aperiodic TRS may be used for early uplink synchronization before LTM cell switch. For example, a PDCCH ordered PRACH transmission delay to an LTM candidate cell may be reduced using the aperiodic TRS. In some cases, the aperiodic TRS may be used for LTM cell switch execution to reduce the interruption time during the LTM cell switch. In some cases, the aperiodic TRS may be used for FR2 high speed train (HST) operations.

In LTM based handovers, if the network entity 105-c triggers the temporary RS (e.g., aperiodic TRS) as part of the MAC-CE command to trigger the cell switch decision, the UE 115-b may decode the aperiodic TRS and use the more accurate TTL or FTL loops resulting in a better RACH performance or improved data channel decoding. For handovers without the aperiodic TRS, the TTL and FTL loops may be sub-optimal as compared to use of the aperiodic TRS. The aperiodic TRS may be made usable from the start of LTM cell switch MAC-CE reception. If LTM cell switch MAC-CE activated TCI state is associated with periodic TRS 390, the UE 115-b may expect the periodic TRS 390 from the target cell during handover procedure. The periodic TRS 390 may not come directly after MAC-CE activation as it is not fully aligned and could be random. In particular, there may be about 10 ms from the LTM command to cell-switch, and depending on the TRS periodicity, the chance to get the periodic TRS 390 may be 10 ms per TRS periodicity. The delays from the periodic TRS 390 is greater than compared to the aperiodic TRS that may be sent directly after handover request.

The LTM cell switch with aperiodic TRS may provide faster handover by triggering the temporary reference signal at an earlier timing than the handover in which the UE 115-b uses the SSB 310 and SSB 315 for automatic gain control (AGC) and tracking before a valid CSI report is available. In some cases, the temporary reference signal (e.g., aperiodic TRS) may contain one or multiple burst (e.g., bursts of TRS) with a gap between the TRS. Each burst may be associated with one or multiple slots, and the gap and length may be provided by RRC signaling. In some cases, the aperiodic TRS 330 may be associated with a single quasi co location (QCL) associated with the periodic TRS 390. The aperiodic reference signal may be supported in both FR1 and FR2. The aperiodic reference signal may be supported in evolved non-standalone dual connectivity (EN-DC) and new radio dual connectivity (NR-DC).

In some examples, the cell switch command (e.g., MAC-CE) may trigger the aperiodic TRS. For example, the UE 115-b may receive, from the network entity 105-c associated with the serving cell, the aperiodic TRS trigger as part of the MAC-CE LTM cell switch command to trigger the handover. The MAC-CE cell switch command may indicate an aperiodic TRS identification in addition to TA, cell identifier, and TCI. In some cases, the aperiodic TRS may be QCL source of active TCI state associated with the periodic TRS of the target cell. In some cases, the configuration for the aperiodic TRS, such as NZP-CSI-RS, may be provided by RRC signaling. In some cases, the MAC-CE cell switch command may trigger the temporary reference signal or aperiodic TRS. The handover procedure with the aperiodic TRS may improve handover latency and boost speed and performance.

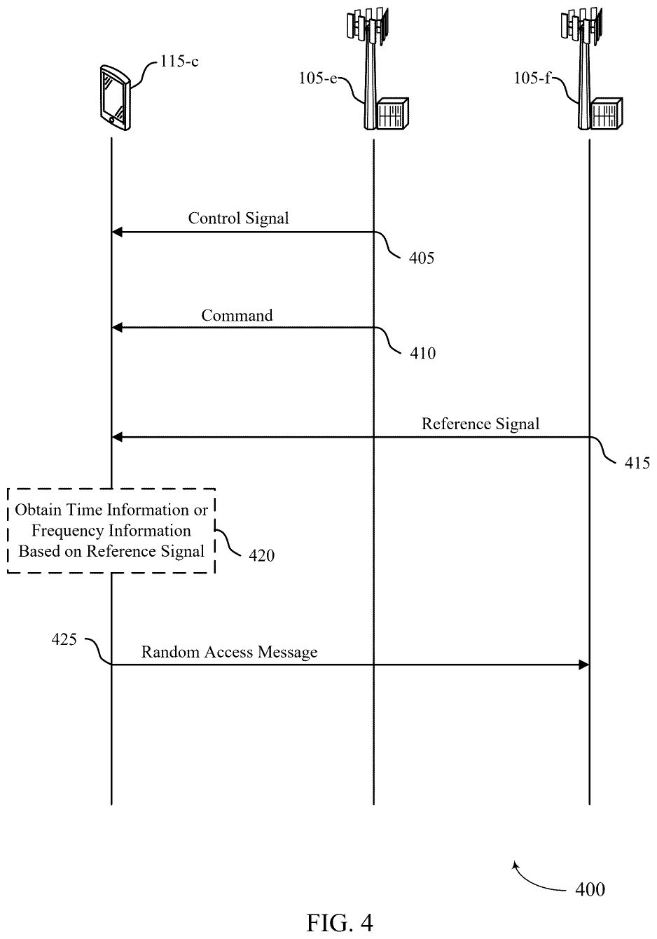

FIG. 4 shows an example of a process flow 400 that supports techniques for cell handover using aperiodic CSI-RS in accordance with one or more aspects of the present disclosure. The process flow 400 may implement or may be implemented by aspects of the wireless communications system 100 and the wireless communications system 200. For example, the process flow 400 may include a UE 115-c, a network entity 105-e, a network entity 105-f, which may be examples of the corresponding devices as described with respect to FIGS. 1 and 2. For example, each network entity may correspond to a respective cell. For example, the network entity 105-e may be associated with a serving cell. The network entity 105-f may be associated with a candidate cell or a target cell. In the following description of the process flow 400, the operations between the UE 115-c, the network entity 105-e, and the network entity 105-f may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-c may receive, from a serving cell, a control signal indicating a set of parameters for a target cell available for handover for the UE 115-b. The control signal may indicate that the target cell is configured to transmit an aperiodic reference signal during a handover procedure.

At 410, the UE 115-c may receive, from the serving cell, a command that identifies the target cell for a handover from the serving cell, and the command may indicate one or more resources associated with the aperiodic reference signal. In some cases, the command may trigger a cell switch procedure or a physical random access channel procedure. In some cases, the command may indicate an identification associated with the one or more resources. In some examples, the command that indicates the one or more resources associated with the aperiodic reference signal as a time duration after reception of the command. In some cases, the command may indicate a quantity of the one or more resources.

At 415, the UE 115-c may receive, from the target cell, the aperiodic reference signal over the one or more resources. In some cases, the UE 115-c may receive the aperiodic reference signal in accordance with a configuration, indicated by the set of parameters, for the one or more resources. In some examples, the configuration for the one or more resources may include a time domain configuration indicating the one or more resources as a time duration after reception of the command, and the UE 115-c may receive the aperiodic reference signal after the time duration. In some cases, the configuration indicates a quantity of the one or more resources. In some cases, the one or more resources may include a first subset of resources and a second subset of resources separated by a time gap. In some cases, the configuration indicates a quantity of the plurality of subsets of resources and indicates a duration for the time gap.

In some cases, a quantity of the one or more resources is based on a frequency range associated with the target cell, a status of the target cell, or a combination thereof. In some cases, the control signal may indicate a plurality of periodic resources associated with periodic reference signals, and the aperiodic reference signal is associated with a single quasi co location (QCL) associated with the periodic reference signals.

At 420, the UE 115-c may obtain time information or frequency information based on the aperiodic reference signal.

At 425, the UE 115-c may transmit, to the target cell, a random access message based on time information or frequency information obtained from the aperiodic reference signal.

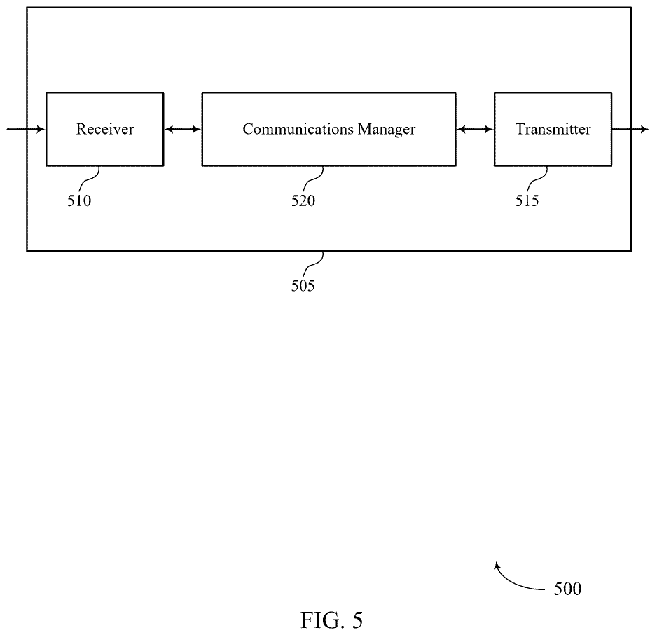

FIG. 5 shows a block diagram 500 of a device 505 that supports techniques for cell handover using aperiodic CSI-RS in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques.

Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for cell handover using aperiodic CSI-RS). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for cell handover using aperiodic CSI-RS). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for cell handover using aperiodic CSI-RS as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a serving cell, a control signal indicating a set of parameters for a target cell available for handover for the UE and indicating the target cell is configured to transmit an aperiodic reference signal during a handover procedure. The communications manager 520 is capable of, configured to, or operable to support a means for receiving, from the serving cell, a command that identifies the target cell for a handover from the serving cell, where the command indicates one or more resources associated with the aperiodic reference signal. The communications manager 520 is capable of, configured to, or operable to support a means for receiving, from the target cell, the aperiodic reference signal over the one or more resources. The communications manager 520 is capable of, configured to, or operable to support a means for transmitting, based on the aperiodic reference signal, a random access message based on time information or frequency information obtained from the aperiodic reference signal.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

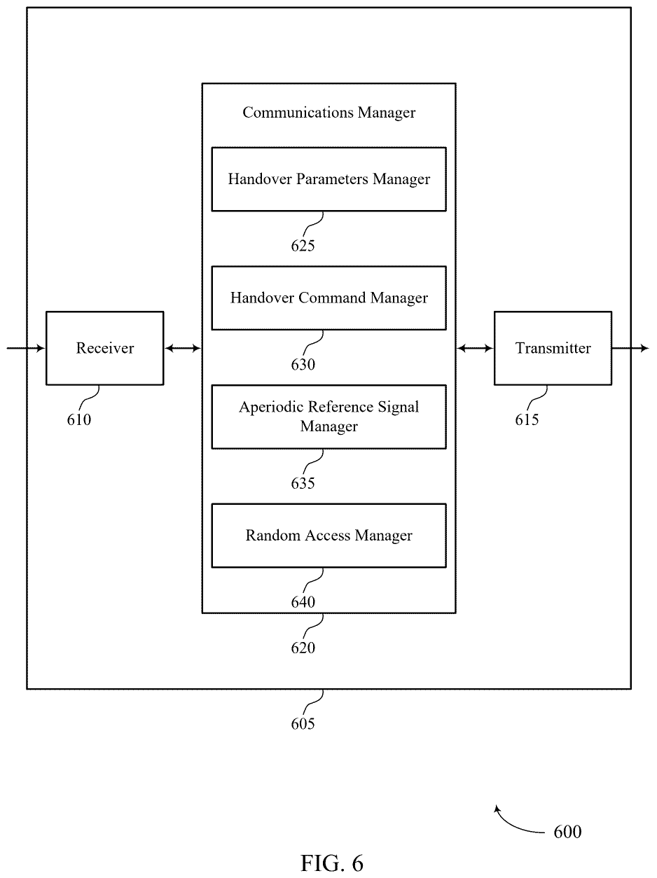

FIG. 6 shows a block diagram 600 of a device 605 that supports techniques for cell handover using aperiodic CSI-RS in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for cell handover using aperiodic CSI-RS). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for cell handover using aperiodic CSI-RS). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for cell handover using aperiodic CSI-RS as described herein. For example, the communications manager 620 may include a handover parameters manager 625, a handover command manager 630, an aperiodic reference signal manager 635, a random access manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The handover parameters manager 625 is capable of, configured to, or operable to support a means for receiving, from a serving cell, a control signal indicating a set of parameters for a target cell available for handover for the UE and indicating the target cell is configured to transmit an aperiodic reference signal during a handover procedure. The handover command manager 630 is capable of, configured to, or operable to support a means for receiving, from the serving cell, a command that identifies the target cell for a handover from the serving cell, where the command indicates one or more resources associated with the aperiodic reference signal. The aperiodic reference signal manager 635 is capable of, configured to, or operable to support a means for receiving, from the target cell, the aperiodic reference signal over the one or more resources. The random access manager 640 is capable of, configured to, or operable to support a means for transmitting, based on the aperiodic reference signal, a random access message based on time information or frequency information obtained from the aperiodic reference signal.

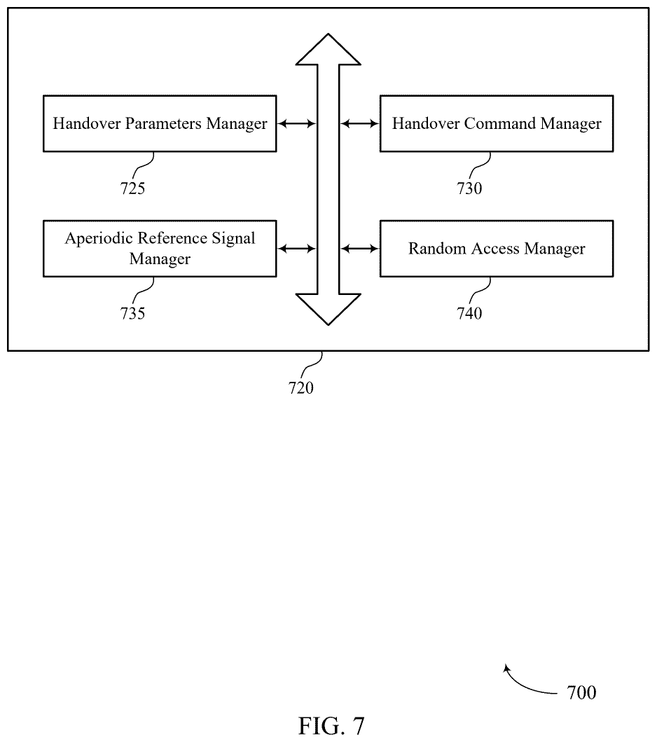

FIG. 7 shows a block diagram 700 of a communications manager 720 that supports techniques for cell handover using aperiodic CSI-RS in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for cell handover using aperiodic CSI-RS as described herein. For example, the communications manager 720 may include a handover parameters manager 725, a handover command manager 730, an aperiodic reference signal manager 735, a random access manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The handover parameters manager 725 is capable of, configured to, or operable to support a means for receiving, from a serving cell, a control signal indicating a set of parameters for a target cell available for handover for the UE and indicating the target cell is configured to transmit an aperiodic reference signal during a handover procedure. The handover command manager 730 is capable of, configured to, or operable to support a means for receiving, from the serving cell, a command that identifies the target cell for a handover from the serving cell, where the command indicates one or more resources associated with the aperiodic reference signal. The aperiodic reference signal manager 735 is capable of, configured to, or operable to support a means for receiving, from the target cell, the aperiodic reference signal over the one or more resources. The random access manager 740 is capable of, configured to, or operable to support a means for transmitting, based on the aperiodic reference signal, a random access message based on time information or frequency information obtained from the aperiodic reference signal.

In some examples, to support receiving the aperiodic reference signal, the aperiodic reference signal manager 735 is capable of, configured to, or operable to support a means for receiving the aperiodic reference signal in accordance with a configuration, indicated by the set of parameters, for the one or more resources.

In some examples, to support receiving the aperiodic reference signal, the aperiodic reference signal manager 735 is capable of, configured to, or operable to support a means for receiving the aperiodic reference signal after the time duration.

In some examples, the configuration indicates a quantity of the one or more resources.

In some examples, the one or more resources include a set of multiple subsets of resources including first subset of resources and a second subset of resources separated by a time gap.

In some examples, the configuration indicates a quantity of the set of multiple subsets of resources and indicates a duration for the time gap.

In some examples, to support receiving the command, the handover command manager 730 is capable of, configured to, or operable to support a means for receiving the command that indicates an identification associated with the one or more resources.

In some examples, to support receiving the command, the handover command manager 730 is capable of, configured to, or operable to support a means for receiving the command that indicates the one or more resources associated with the aperiodic reference signal as a time duration after reception of the command, where receiving the aperiodic reference signal includes receiving the aperiodic reference signal after the time duration. In some examples, to support receiving the command, the aperiodic reference signal manager 735 is capable of, configured to, or operable to support a means for receiving the aperiodic reference signal after the time duration.

In some examples, to support receiving the command, the handover command manager 730 is capable of, configured to, or operable to support a means for receiving the command that indicates a quantity of the one or more resources.

In some examples, a quantity of the one or more resources is based on a frequency range associated with the target cell, a status of the target cell, or a combination thereof.

In some examples, to support receiving the command, the handover command manager 730 is capable of, configured to, or operable to support a means for receiving the command that triggers a cell switch procedure or a physical random access channel procedure.

In some examples, to support receiving the control signal, the handover parameters manager 725 is capable of, configured to, or operable to support a means for receiving the control signal that indicates a set of multiple periodic resources associated with periodic reference signals, where the aperiodic reference signal is associated with a single quasi co location (QCL) associated with the periodic reference signals.

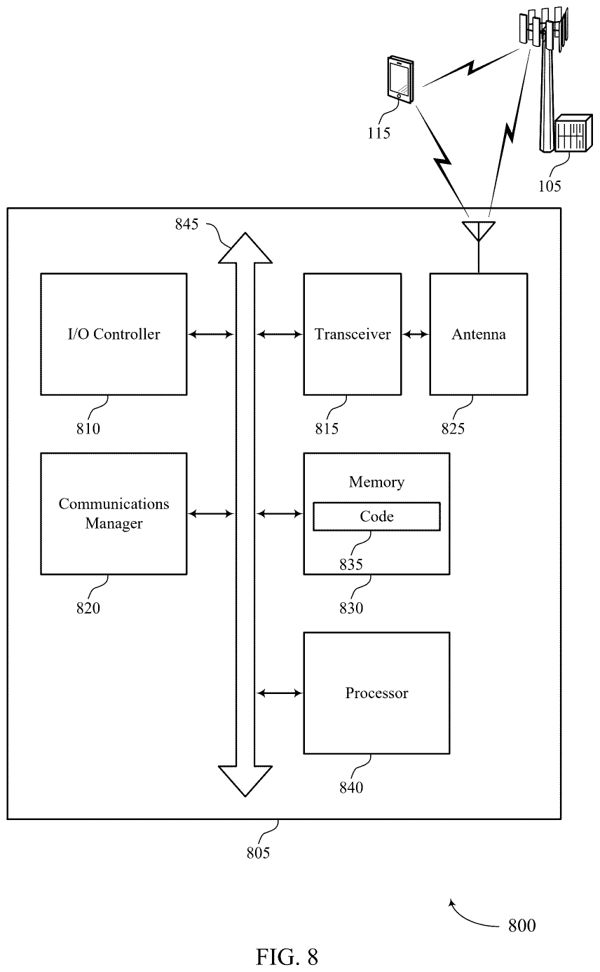

FIG. 8 shows a diagram of a system 800 including a device 805 that supports techniques for cell handover using aperiodic CSI-RS in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for cell handover using aperiodic CSI-RS). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a serving cell, a control signal indicating a set of parameters for a target cell available for handover for the UE and indicating the target cell is configured to transmit an aperiodic reference signal during a handover procedure. The communications manager 820 is capable of, configured to, or operable to support a means for receiving, from the serving cell, a command that identifies the target cell for a handover from the serving cell, where the command indicates one or more resources associated with the aperiodic reference signal. The communications manager 820 is capable of, configured to, or operable to support a means for receiving, from the target cell, the aperiodic reference signal over the one or more resources. The communications manager 820 is capable of, configured to, or operable to support a means for transmitting, based on the aperiodic reference signal, a random access message based on time information or frequency information obtained from the aperiodic reference signal.

By including or configuring the communications manager 820 in accordance with examples as described herein, the device 805 may support techniques for reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for cell handover using aperiodic CSI-RS as described herein, or the at least one processor 840 and the at least one memory 830 may be otherwise configured to, individually or collectively, perform or support such operations.

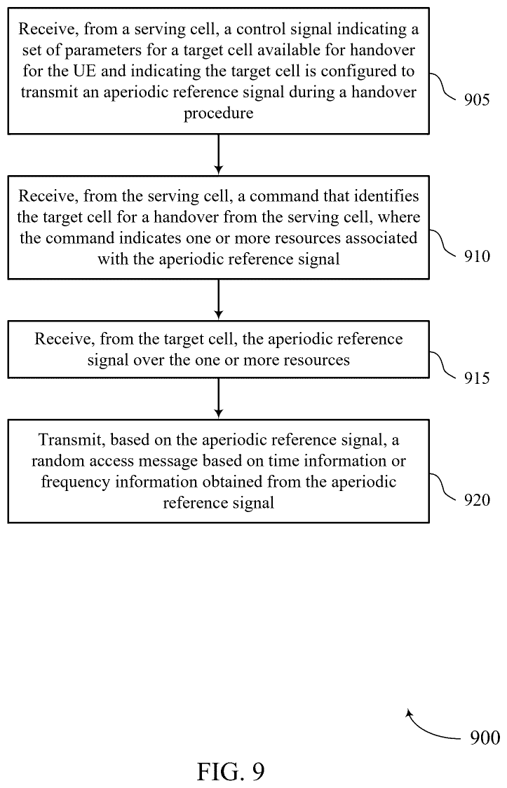

FIG. 9 shows a flowchart illustrating a method 900 that supports techniques for cell handover using aperiodic CSI-RS in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a serving cell, a control signal indicating a set of parameters for a target cell available for handover for the UE and indicating the target cell is configured to transmit an aperiodic reference signal during a handover procedure. The operations of 905 may be performed in accordance with examples as disclosed herein. In some examples, aspects of the operations of 905 may be performed by a handover parameters manager 725 as described with reference to FIG. 7.

At 910, the method may include receiving, from the serving cell, a command that identifies the target cell for a handover from the serving cell, where the command indicates one or more resources associated with the aperiodic reference signal. The operations of 910 may be performed in accordance with examples as disclosed herein. In some examples, aspects of the operations of 910 may be performed by a handover command manager 730 as described with reference to FIG. 7.

At 915, the method may include receiving, from the target cell, the aperiodic reference signal over the one or more resources. The operations of 915 may be performed in accordance with examples as disclosed herein. In some examples, aspects of the operations of 915 may be performed by an aperiodic reference signal manager 735 as described with reference to FIG. 7.

At 920, the method may include transmitting, based on the aperiodic reference signal, a random access message based on time information or frequency information obtained from the aperiodic reference signal. The operations of 920 may be performed in accordance with examples as disclosed herein. In some examples, aspects of the operations of 920 may be performed by a random access manager 740 as described with reference to FIG. 7.

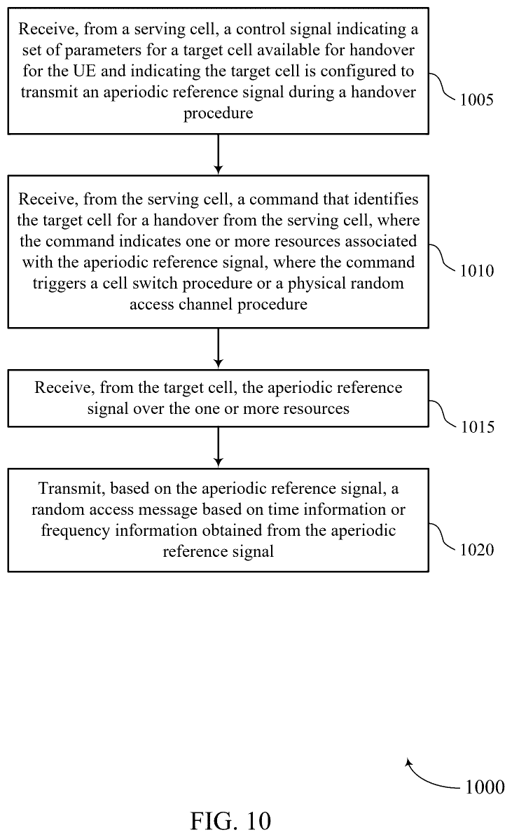

FIG. 10 shows a flowchart illustrating a method 1000 that supports techniques for cell handover using aperiodic CSI-RS in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a serving cell, a control signal indicating a set of parameters for a target cell available for handover for the UE and indicating the target cell is configured to transmit an aperiodic reference signal during a handover procedure. The operations of 1005 may be performed in accordance with examples as disclosed herein. In some examples, aspects of the operations of 1005 may be performed by a handover parameters manager 725 as described with reference to FIG. 7.

At 1010, the method may include receiving, from the serving cell, a command that identifies the target cell for a handover from the serving cell, where the command indicates one or more resources associated with the aperiodic reference signal, where the command triggers a cell switch procedure or a physical random access channel procedure. The operations of 1010 may be performed in accordance with examples as disclosed herein. In some examples, aspects of the operations of 1010 may be performed by a handover command manager 730 as described with reference to FIG. 7.

At 1015, the method may include receiving the command that indicates an identification associated with the one or more resources. The operations of 1015 may be performed in accordance with examples as disclosed herein. In some examples, aspects of the operations of 1015 may be performed by a handover command manager 730 as described with reference to FIG. 7.

At 1020, the method may include receiving, from the target cell, the aperiodic reference signal over the one or more resources. The operations of 1020 may be performed in accordance with examples as disclosed herein. In some examples, aspects of the operations of 1020 may be performed by an aperiodic reference signal manager 735 as described with reference to FIG. 7.

At 1025, the method may include transmitting, based on the aperiodic reference signal, a random access message based on time information or frequency information obtained from the aperiodic reference signal. The operations of 1025 may be performed in accordance with examples as disclosed herein. In some examples, aspects of the operations of 1025 may be performed by a random access manager 740 as described with reference to FIG. 7.

The following provides an overview of aspects of the present disclosure:

Aspect 1: A method for wireless communications by a UE, comprising: receiving, from a serving cell, a control signal indicating a set of parameters for a target cell available for handover for the UE and indicating the target cell is configured to transmit an aperiodic reference signal during a handover procedure; receiving, from the serving cell, a command that identifies the target cell for a handover from the serving cell, wherein the command indicates one or more resources associated with the aperiodic reference signal; receiving, from the target cell, the aperiodic reference signal over the one or more resources; and transmitting, based at least in part on the aperiodic reference signal, a random access message based at least in part on time information or frequency information obtained from the aperiodic reference signal.

Aspect 2: The method of aspect 1, wherein receiving the aperiodic reference signal comprises: receiving the aperiodic reference signal in accordance with a configuration, indicated by the set of parameters, for the one or more resources.

Aspect 3: The method of aspect 2, wherein the configuration of the one or more resources comprises a time domain configuration indicating the one or more resources as a time duration after reception of the command, wherein receiving the aperiodic reference signal comprises: receiving the aperiodic reference signal after the time duration.

Aspect 4: The method of aspect 2, wherein the configuration indicates a quantity of the one or more resources.

Aspect 5: The method of aspect 2, wherein the one or more resources comprise a plurality of subsets of resources including first subset of resources and a second subset of resources separated by a time gap.

Aspect 6: The method of aspect 5, wherein the configuration indicates a quantity of the plurality of subsets of resources and indicates a duration for the time gap.

Aspect 7: The method of aspect 1, wherein receiving the command comprises: receiving the command that indicates an identification associated with the one or more resources.

Aspect 8: The method of aspect 1 7, wherein receiving the command comprises: receiving the command that indicates the one or more resources associated with the aperiodic reference signal as a time duration after reception of the command, wherein receiving the aperiodic reference signal comprises: receiving the aperiodic reference signal after the time duration.

Aspect 9: The method of aspect 1, wherein receiving the command comprises: receiving the command that indicates a quantity of the one or more resources.

Aspect 10: The method of aspect 1, wherein a quantity of the one or more resources is based at least in part on a frequency range associated with the target cell, a status of the target cell, or a combination thereof.

Aspect 11: The method of aspect 1, wherein receiving the command comprises: receiving the command that triggers a cell switch procedure or a physical random access channel procedure.

Aspect 12: The method of aspect 1, wherein receiving the control signal comprises: receiving the control signal that indicates a plurality of periodic resources associated with periodic reference signals, wherein the aperiodic reference signal is associated with a single QCL associated with the periodic reference signals.

Aspect 13: A UE for wireless communications, comprising one or more memories storing processor-executable code, and one or more processors coupled with the one or more memories and individually or collectively operable to execute the code to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a serving cell, a control signal indicating a set of parameters for a target cell available for handover for the UE and indicating the target cell is configured to transmit an aperiodic reference signal during a handover procedure;
receive, from the serving cell, a command that identifies the target cell for a handover from the serving cell, wherein the command indicates one or more resources associated with the aperiodic reference signal;
receive, from the target cell, the aperiodic reference signal over the one or more resources; and
transmit, based at least in part on the aperiodic reference signal, a random access message based at least in part on time information or frequency information obtained from the aperiodic reference signal.

2. The UE of claim 1, wherein, to receive the aperiodic reference signal, the one or more processors are individually or collectively operable to execute the code to cause the UE to:
receive the aperiodic reference signal in accordance with a configuration, indicated by the set of parameters, for the one or more resources.

3. The UE of claim 2, wherein, to receive the aperiodic reference signal, the one or more processors are individually or collectively operable to execute the code to cause the UE to:
receive the aperiodic reference signal after a time duration.

4. The UE of claim 2, wherein the configuration indicates a quantity of the one or more resources.

5. The UE of claim 2, wherein the one or more resources comprise a plurality of subsets of resources including first subset of resources and a second subset of resources separated by a time gap.

6. The UE of claim 5, wherein the configuration indicates a quantity of the plurality of subsets of resources and indicates a duration for the time gap.

7. The UE of claim 1, wherein, to receive the command, the one or more processors are individually or collectively operable to execute the code to cause the UE to:
receive the command that indicates an identification associated with the one or more resources.

8. The UE of claim 1, wherein, to receive the command, the one or more processors are individually or collectively operable to execute the code to cause the UE to:
receive the command that indicates the one or more resources associated with the aperiodic reference signal as a time duration after reception of the command, wherein receiving the aperiodic reference signal comprises:
receive the aperiodic reference signal after the time duration.

9. The UE of claim 1, wherein, to receive the command, the one or more processors are individually or collectively operable to execute the code to cause the UE to:
receive the command that indicates a quantity of the one or more resources.

10. The UE of claim 1, wherein a quantity of the one or more resources is based at least in part on a frequency range associated with the target cell, a status of the target cell, or a combination thereof.

11. The UE of claim 1, wherein, to receive the command, the one or more processors are individually or collectively operable to execute the code to cause the UE to:
receive the command that triggers a cell switch procedure or a physical random access channel procedure.

12. The UE of claim 1, wherein, to receive the control signal, the one or more processors are individually or collectively operable to execute the code to cause the UE to:
receive the control signal that indicates a plurality of periodic resources associated with periodic reference signals, wherein the aperiodic reference signal is associated with a single quasi co location (QCL) associated with the periodic reference signals.

13. A method for wireless communications by a user equipment (UE), comprising:
receiving, from a serving cell, a control signal indicating a set of parameters for a target cell available for handover for the UE and indicating the target cell is configured to transmit an aperiodic reference signal during a handover procedure;
receiving, from the serving cell, a command that identifies the target cell for a handover from the serving cell, wherein the command indicates one or more resources associated with the aperiodic reference signal;
receiving, from the target cell, the aperiodic reference signal over the one or more resources; and
transmitting, based at least in part on the aperiodic reference signal, a random access message based at least in part on time information or frequency information obtained from the aperiodic reference signal.

14. The method of claim 13, wherein receiving the aperiodic reference signal comprises:
receiving the aperiodic reference signal in accordance with a configuration, indicated by the set of parameters, for the one or more resources.

15. The method of claim 14, wherein the configuration of the one or more resources comprises a time domain configuration indicating the one or more resources as a time duration after reception of the command, wherein receiving the aperiodic reference signal comprises:
receiving the aperiodic reference signal after the time duration.

16. The method of claim 14, wherein the configuration indicates a quantity of the one or more resources.

17. The method of claim 14, wherein the one or more resources comprise a plurality of subsets of resources including first subset of resources and a second subset of resources separated by a time gap.

18. The method of claim 13, wherein receiving the command comprises:
receiving the command that indicates an identification associated with the one or more resources.

19. The method of claim 13, wherein receiving the command comprises:
receiving the command that indicates the one or more resources associated with the aperiodic reference signal as a time duration after reception of the command, wherein receiving the aperiodic reference signal comprises:
receiving the aperiodic reference signal after the time duration.

20. A non-transitory computer-readable medium storing code for wireless communications, the code comprising instructions executable by one or more processors to:
receive, from a serving cell, a control signal indicating a set of parameters for a target cell available for handover and indicating the target cell is configured to transmit an aperiodic reference signal during a handover procedure;
receive, from the serving cell, a command that identifies the target cell for a handover from the serving cell, wherein the command indicates one or more resources associated with the aperiodic reference signal;
receive, from the target cell, the aperiodic reference signal over the one or more resources; and
transmit, based at least in part on the aperiodic reference signal, a random access message based at least in part on time information or frequency information obtained from the aperiodic reference signal.
